(19) United States
(12) Patent Application Publication
(10) Pub. No.: US 2023/0321506 A1
(43) Pub. Date: Oct. 12, 2023

(54) ILLUMINATED PADDLES

(71) Applicant: Brightz, Ltd., Ottawa Lake, MI (US)

(72) Inventors: Brian Finch, Ypsilanti, MI (US); James McAllister, Perrysburg, OH (US)

(73) Assignee: Brightz, Ltd., Ottawa Lake, MI (US)

(21) Appl. No.: 18/131,919

(22) Filed: Apr. 7, 2023

Related U.S. Application Data
(60) Provisional application No. 63/328,889, filed on Apr. 8, 2022.

(51) Int. Cl. A63B 59/42; F21V 33/00; F21V 8/00

(52) U.S. Cl. CPC A63B 59/42; F21V 33/008; G02B 6/001; A63B 2225/74; A63B 2102/16

(57) ABSTRACT

An illuminated paddle includes a frame comprising a paddle portion, a handle portion extending from the paddle portion, a perimeter that extends around the paddle portion and the handle portion, and a channel positioned along at least a portion of the perimeter, the paddle portion comprising a plurality of internal strength members that define a plurality of cavities, a light source assembly disposed at an end of the handle portion, the light source assembly comprising at least one light source, and a light pipe disposed within at least a portion of the channel of the frame, the light pipe is optically coupled to the at least one light source.

### CROSS-REFERENCE TO RELATED APPLICATION

This application claims priority to U.S. Provisional Application No. 63/328,889 filed Apr. 8, 2022, the disclosure of which is incorporated herein by reference in its entirety.

### TECHNICAL FIELD

The present specification relates to illumination devices, and more specifically to illuminated paddles and racquets.

### BACKGROUND

Paddles and rackets are used in a variety of sports and games, such as ping pong (i.e., table tennis), tennis, racquet ball, and pickleball, among others. The paddles and rackets (collectively referred to herein as “paddles”) are used to hit a ball or shuttlecock either toward an opponent or a wall surface, for example.

### SUMMARY

In one embodiment, an illuminated paddle includes a frame comprising a paddle portion, a handle portion extending from the paddle portion, a perimeter that extends around the paddle portion and the handle portion, and a channel positioned along at least a portion of the perimeter, the paddle portion comprising a plurality of internal strength members that define a plurality of cavities, a light source assembly disposed at an end of the handle portion, the light source assembly comprising at least one light source, and a light pipe disposed within at least a portion of the channel of the frame, wherein the light pipe is optically coupled to the at least one light source.

In another embodiment, an illuminated paddle includes a frame comprising a paddle portion, a handle portion extending from the paddle portion, a perimeter that extends around the paddle portion and the handle portion, and a channel positioned along at least a portion of the perimeter, the paddle portion comprising a plurality of internal strength members that define a plurality of cavities, a light source assembly disposed at an end of the handle portion, the light source assembly comprising at least one light source, a light pipe disposed within at least a portion of the channel of the frame, wherein the light pipe is optically coupled to the at least one light source, a first rubber layer secured to a first face of the paddle portion of the frame, a second rubber layer secured to a second face opposite the first face of the paddle portion of the frame, a cavity formed in the handle portion of the frame, the cavity is sized to receive and retain a battery, and two grips, each of the two grips secured to opposing faces of the handle portion of the frame and enclose the battery disposed within the cavity of the handle portion of the frame.

These and additional features provided by the embodiments described herein will be more fully understood in view of the following detailed description, in conjunction with the drawings.

### BRIEF DESCRIPTION OF THE FIGURES

The embodiments set forth in the drawings are illustrative and exemplary in nature and are not intended to limit the disclosure. The following detailed description of the illustrative embodiments can be understood when read in conjunction with the following drawings, where like structure is indicated with like reference numerals.

FIG. 1 illustrates an example illuminated paddle according to one or more embodiments described and illustrated herein;

FIG. 2 illustrates the example illuminated paddle of FIG. 1 in an orange illuminated state according to one or more embodiments described and illustrated herein;

FIG. 3 illustrates an example light pipe for an illuminated paddle according to one or more embodiments described and illustrated herein;

FIG. 4 illustrates an example frame for an illuminated paddle according to one or more embodiments described and illustrated herein;

FIG. 5 illustrates an example frame shell for an illuminated paddle according to one or more embodiments described and illustrated herein;

FIG. 6 illustrates example foam and rubber layers, handle shells, electronics housing, printed circuit board and battery for an illuminated paddle according to one or more embodiments described and illustrated herein;

FIG. 7A illustrates a side view of an example paddle without a light strip according to one or more embodiments described and illustrated herein;

FIG. 7B illustrates another side view of the example paddle of FIG. 7 without a light strip according to one or more embodiments described and illustrated herein;

FIG. 8 illustrates an example electronics housing according to one or more embodiments described and illustrated herein;

FIG. 9 illustrates an example printed circuit board according to one or more embodiments described and illustrated herein;

FIG. 10 illustrates another frame for an illuminated paddle according to one or more embodiments described and illustrated herein;

FIG. 11 illustrates another frame for an illuminated paddle according to one or more embodiments described and illustrated herein;

FIG. 12 illustrates another frame for an illuminated paddle according to one or more embodiments described and illustrated herein;

FIG. 13 illustrates another frame for an illuminated paddle according to one or more embodiments described and illustrated herein;

FIG. 14 illustrates another frame for an illuminated paddle according to one or more embodiments described and illustrated herein; and

FIG. 15 illustrates an exploded component view of the illuminated paddle according to one or more embodiments described and illustrated herein.

### DETAILED DESCRIPTION

References will now be made in detail to the embodiments of the disclosure, examples of which are illustrated in the accompanying drawings. Whenever possible, like reference numbers will be used to refer to like components or parts.

Embodiments of the present disclosure are directed toward illuminated paddles and rackets (collectively referred to herein as “paddles”) used on sports and recreational games, such as ping pong (i.e., table tennis), tennis, racquet ball, and pickleball, among others. The paddles are used to hit a ball or shuttlecock either toward an opponent or a wall surface, for example. The paddles described herein are illuminated with custom and/or morphing colors to provide customizable and unique paddles for users.

It is desirable to apply light sources to paddles so that a user may customize his or her paddle for recreation and/or training activities. However, paddles have strict weight requirements. The addition of batteries, LEDs, and electronics will add weight to the paddle. Further, paddles have a certain “feel” when they make contact with a ball. The addition of batteries, LEDs, and electronics may affect the “feel” of the paddle, which may be undesirable for a user. As such, embodiments of the present disclosure provide for illuminated paddles that have a weight and feel similar to that of a traditional paddle. Particularly, embodiments provide one or more light sources within a handle of the paddle that are optically coupled to a light pipe that extends around at least a portion of the perimeter of the paddle.

As described in more detail below, embodiments provide one or more light sources within a handle of the paddle that are optically coupled to a light pipe that extends around at least a portion of the perimeter of the paddle. The user may change to a particular static color or select one or more color changing/morphing modes by pressing a button within the handle. Some embodiments may utilize a light pipe and light sources to illuminate the paddle, other embodiments may utilize alternative illumination methods. For example, the light pipe may be interchanged with microwire LEDs, LED strip lights, rope LEDs, optical fiber LEDs, light-diffusing fiber (e.g., Fibrance®), or a combination of other light sources positions around the perimeter of the paddle or configured to illuminate material thereof.

Additionally, in some embodiments, the type of the illumination, such as the brightness, intermittent flashing, and the like, or the color of the illumination may be configured to change in response to movement of the paddle and/or contact of the paddle with the ball. Such an embodiment may be utilized for training activities or provide feedback to game play. For example, in some embodiments, one or more sensors embedded within the paddle may be configured to sense the an acceleration and/or speed of movement of the paddle, a force of contact between the paddle and ball, a location of contact with ball on the surface of the paddle and the like. The type and/or color of illumination may be preconfigured to change in response to specified movements, forces, and/or locations of contact that the one or more sensors detect.

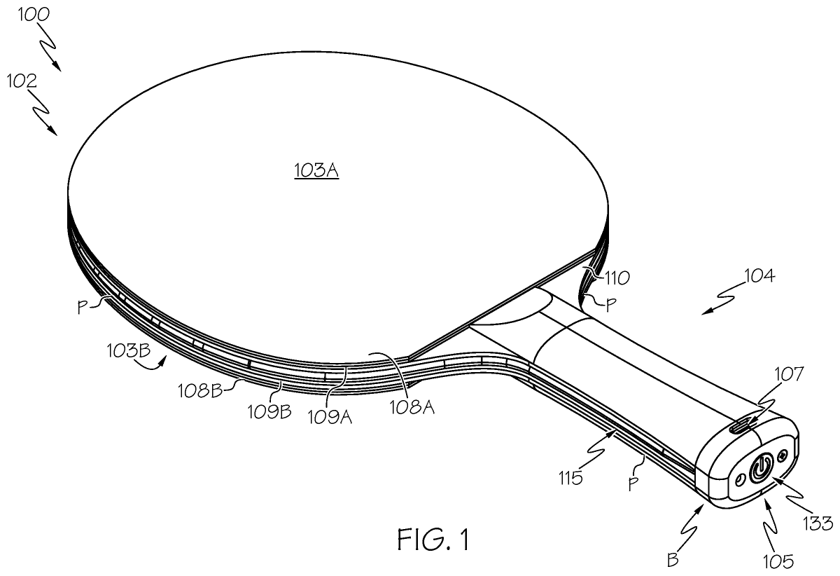

Turning now to the drawings where like numbers refer to like structures, embodiments of the illuminated paddles are described in more detail. Referring to FIG. 1, a non-limiting example of a paddle 100 configured as a ping pong paddle is illustrated. It should be understood that the concepts described herein may be extended to any type of paddle or racket. Generally, the paddle 100 includes a paddle portion 102 and a handle portion 104 that extends from the paddle portion 102. The paddle 100 has a perimeter P that extends around at least a portion of the paddle 100 such as, without limitation, the entire paddle portion 102 and a part of the handle portion 104.

The paddle portion 102 and the handle portion 104 are defined at least in part by a frame 110 that gives the paddle 100 its paddle shape. The frame 110 defines the planar shape of the paddle and provides a structure for supporting components of the paddle portion 102 and components of the handle portion 104.

The paddle portion 102 has a two faces 103A, 103B one of each side of the frame 110 such that the two faces 103A, 103B oppose each other. Each of the two faces 103A, 103B support a foam layer 109A, 109B, respectively, and a rubber layer 108A, 108B respectively. However, it is understood that in some embodiments the paddle portion 102 may not include a foam layer 109A, 109B and instead include a rubber layer 108A, 108B directly supported by the frame 110. The frame 110 may comprise wood, plastic, or other composite material capable of holding a rigid form. Furthermore, while the present disclosure is provided in the context of a ping pong paddle, it is understood that the two faces 103 may be defined by strings such as a tennis racquet.

Referring back to FIG. 1, the foam layer 109A, 109B may be adhered directly onto the frame 110 and the rubber layer 108A, 108B may be adhered onto the foam layer 109A, 109B. It should be understood that in some embodiments, no foam layer 109A, 109B or rubber layer 108A, 108B is provided, or only one of the foam layer 109A, 109B and the rubber layer 108A, 108B is provided. It is understood that the rubber layer may comprise a material having similar properties to rubber but is not rubber material.

In some embodiments, the foam layers 109 and/or the rubber layers 108 may comprise a light absorbing and light emitting material, for example a material containing phosphors, for example, which can radiate light after they have received energy from a light source. For example, a light source (e.g., positioned within the paddle 100 or positioned to project light from a top portion or a surface of the handle portion 104 to the paddle portion) may cause the phosphors to receive light energy and subsequently emit the retained energy.

Additionally, the foam layers 109 and/or the rubber layers 108 may comprise a material that is transparent or semi-transparent so that in embodiments where the frame is made of material capable of transmitting and diffusing light (e.g. acrylic or other clear or semi-transparent material), the light from the frame may be emitted through the foam layers 109 and/or the rubber layers 108. In some embodiments, the foam layers 109 and/or the rubber layers 108 may include cutaway portions, for example, forming designs and/or patterns therein which may be illuminated from light transmitted through the frame.

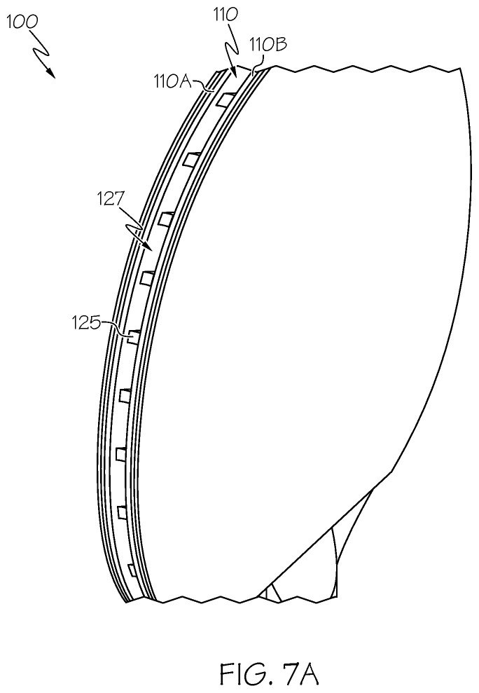

As described in more detail below, a light pipe 115 is disposed within a channel 127 (see FIG. 7A) of the frame 110 around at least a portion of the perimeter P of the paddle 100. The light pipe 115 is secured to the frame 110 by one or more methods. For example, in embodiments, an adhesive may bond the light pipe 115 to the frame 110 within the channel 127 (see FIG. 7A) defined along at least a portion of the perimeter P of the paddle 100. In the same embodiment or other embodiments, the channel 127 may be formed to provide an interference fit with the light pipe 115 so that the light pipe 115 can be secured to the frame 110 with or without adhesive. In some embodiments, fasteners or other retaining features may be used to attach the light pipe 115 to the frame 110. Using a light pipe 115 having a consistent cross-sectional geometry along its length enables control of the weight distribution of the light pipe 115 as a component of the paddle 100 such that it can be efficiently managed thereby maintaining balance and weight distribution within the paddle 100. Additionally, electronics that generate and control the light can be optimally positioned within the paddle 100, for example, within the handle portion 104 of the paddle 100 so that the paddle 100 can provide the feel and play expected of a traditional non-illuminated paddle.

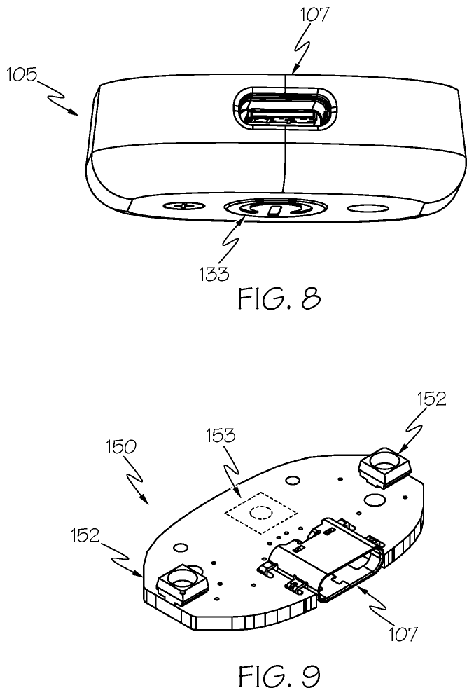

An electronics housing 105 maintains a charger port 107, control electronics, and one or more light sources 152 (see FIG. 9) that are optically coupled to the light pipe 115. Light from the one or more light sources propagates within the light pipe 115, which also diffuses the light outwardly away from the light pipe 115 so that the colored light is visible to observers.

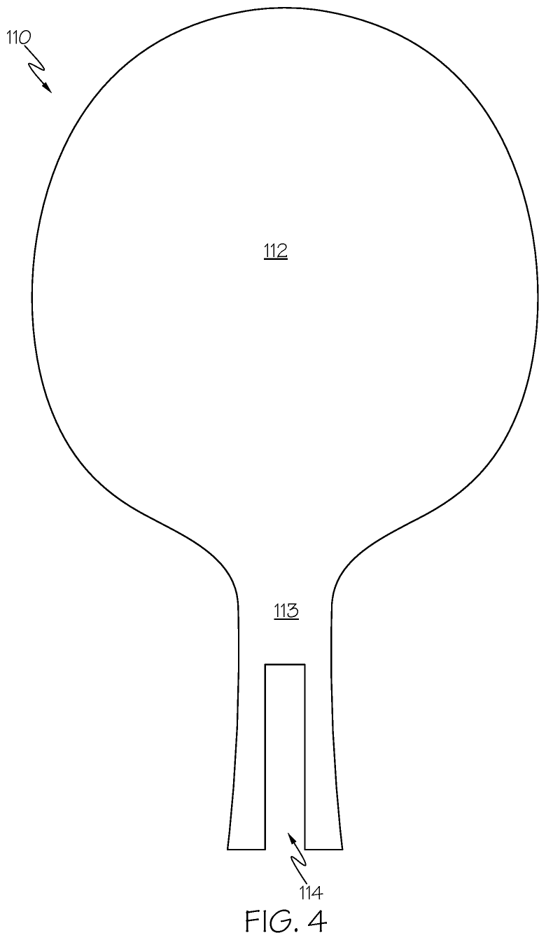

The handle portion 104 extends from the paddle portion 102. Additionally, the perimeter P extends from the paddle portion 102 along the length of the handle portion 104 as shown in FIG. 1, for example. The handle portion 104 portion defines a portion of the frame 110 in which a user may hold when interacting with the paddle during game play. To facilitate grip of the paddle 100 by a user the handle portion 104 includes grips 130A and 130B fixed to and supported by the handle portion 104 of the frame 110. The grips 130A and 130B enclose a cavity 114 formed in the handle portion 104 of the frame 110 as depicted, for example, in at least FIG. 4 and which will be described in more detail herein.

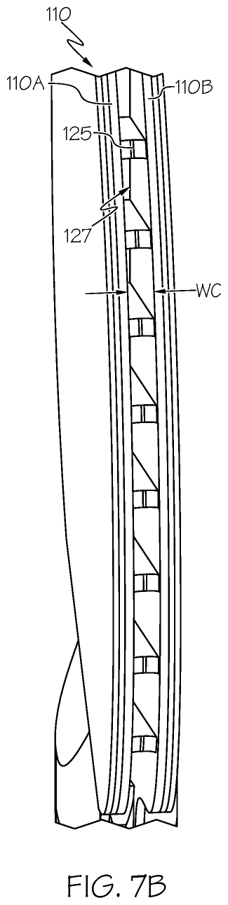

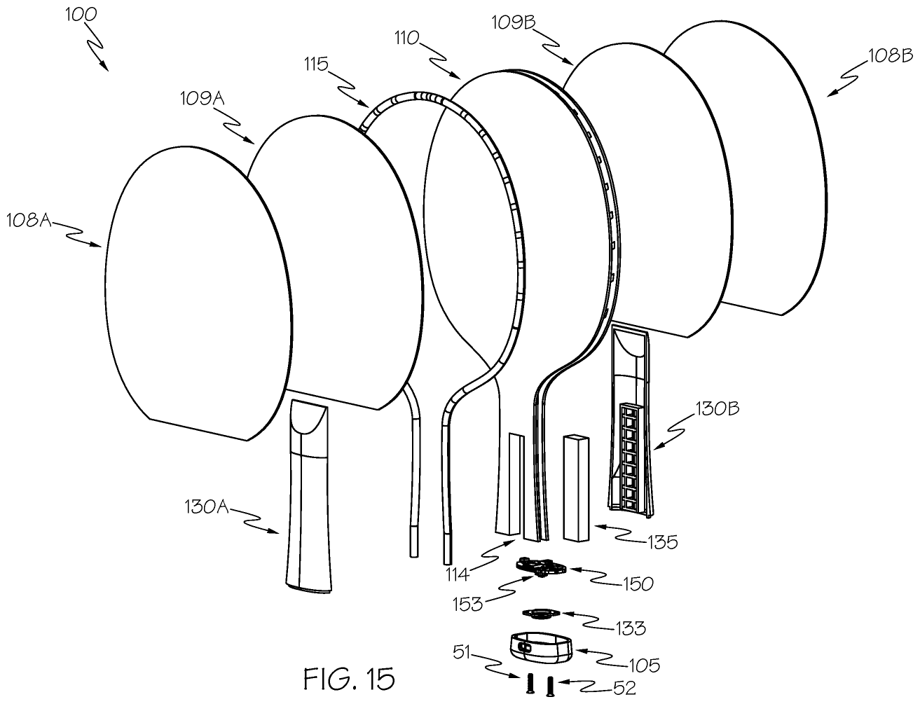

Additionally, the handle portion 104 includes an electronics housing 105. In some embodiments, the electronics housing 105 is formed as part of the handle portion 104. In some embodiments, the electronics housing 105 is coupled to the handle portion 104 of the frame 110 (e.g., by fasteners 51 and 52 shown in FIG. 15). The electronics housing 105 is located on the end of the handle portion 104 opposite the paddle portion 102 of the paddle 100. However, in some embodiments, the electronics housing 105 may be disposed within the handle portion 104 and/or the paddle portion 102 at different locations. For example, in an embodiment, the one or more light sources and/or other components housed by the electronics housing 105 may be positioned at the top of the handle portion 104 (e.g., where the handle portion 104 extends into the paddle portion 102) or at various locations throughout the paddle portion 102. For example, in one embodiment, the light source may be positioned in a central region of the paddle portion such that illumination of the light source causes the material (e.g., a transparent or translucent material) of the frame 110 to be illuminated and further illuminating the perimeter and/or the faces of the paddle 100. The electronics housing 105 encapsulates within a housing material the electronics for providing illumination to the paddle 100. In some embodiments, for example, rechargeable versions of the paddle 100, the electronics housing 105 includes an opening in the housing material for providing access to a charger port 107. Additionally, the electronics housing 105 includes a button cover 132 for a user to interface with an electronic button 153. The electronics housing 105 and the electronics for providing illumination to the paddle 100 will be described in more detail with reference to FIGS. 8 and 9.

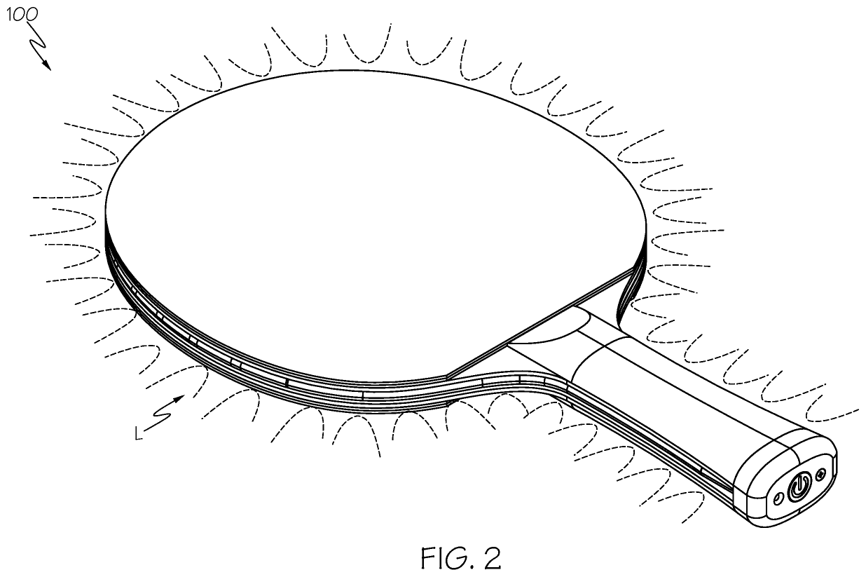

In operation, the light pipe 115 propagates light from the one or more light sources 152 (see FIG. 9) and also diffuses a portion of the light outwardly away from the light pipe 115 so that the colored light is visible to observers. FIG. 2 illustrates a view of the paddle 100 that is illuminated by light (L). The light (L) may be colored light such as white, red, yellow, orange, green, blue, purple, brown, or the like. The light (L) may vary in brightness (e.g. lumen output) over time or be fixed to a preset illumination value.

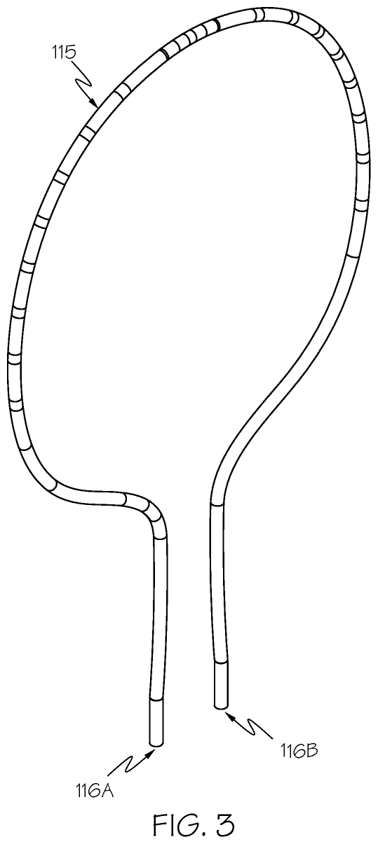

Referring to FIG. 3, an example light pipe 115 that is disposed within the frame 110 around a perimeter P of the paddle 100 is illustrate. The light pipe 115 may be made of a compliant material, such as a plastic, such that it may be bent and shaped to the profile of the perimeter P of the paddle 100. The light pipe 115 may have a cross-sectional shape defined by a circle, oval, square, triangle or the like. The light pipe 115 depicted in FIG. 3 has a circular cross-sectional shape. However, this is only an example and other shapes may be implemented to correspond to the shape of the channel 127 (see FIG. 7A). Additionally, the light pipe 115 includes a first end 116A and a second end 116B. At least one of the first end 116A or the second end 116B receives light from a light source. To receive light from the light source the at least one of the first end 116A or the second end 116B is positioned in close proximity to the light source and aligned so that light is projected into the cross-sectional end of the light pipe 115.

Other embodiments may utilize alternative illumination methods. For example, the light pipe may be interchanged with microwire LEDs, LED strip lights, rope LEDs, optical fiber LEDs, light-diffusing fiber (e.g., Fibrance®), or a combination of other light sources positions around the perimeter of the paddle or configured to illuminate material thereof. The illumination methods may further include a lens and/or diffusion cover to provide a desired illumination effect along the perimeter P of the paddle 100 and or on the face of the paddle 100.

Referring now to FIG. 4, an example frame 110 of the paddle 100 shown in FIGS. 1 and 2 is illustrated. The frame 110 has a paddle face 112 (e.g., a front paddle face and back paddle face which is opposite the front paddle face and not shown in FIG. 4) and a handle face 113 (e.g., a front handle face and back handle face which is opposite the front handle face and not shown in FIG. 4) that extends from the paddle face 112. The frame 110 may include a geometric structure defining the structure between the front paddle face and the back paddle face. The geometric structure may be a solid fill. However, in some embodiments, to achieve a predetermined weight of the paddle 100, a weight distribution across the paddle 100, and/or a feel of play from the surfaces of the paddle 100, a geometric structure which includes open space within the frame 110 of the paddle 100 is implemented.

The frame 110 may be made from a rigid plastic in some embodiments. The frame 110 may be made by three-dimensional printing, injection molding, or a subtractive manufacturing process. The frame 110 may be fabricated by two shells that are brought together or, alternatively, the frame 110 may be a single, unitary component.

In some embodiments, the frame may comprise a composite material such as a combination of wood and plastic (or like material) where the plastic forming the frame is configured to operate as a light pipe such that light from a light source illuminates the plastic and is further diffused therefrom such that the frame is illuminated. Some paddles 100 may comprise a composite of wood and plastic components. For example, the central portion of the paddle 100 may be made of wood while portions of the perimeter include a ring of plastic designed to house and retain a light pipe or other illumination source. In this way the lightweight wood is used for the body and the heavier plastic has minimal impact to the “feel” of the paddle 100 during play.

By way of a further example, the frame may be may entirely from wood and a channel, as described herein, may be routed along the perimeter to retain a light pipe 115.

As another example, the frame may be formed using light diffusing material such as acrylic, plexiglass, or the like and one or more light sources a positioned to illuminated the light diffusing material such that the entire material is illuminated and textured edges or surfaces of the frame cause the light to be diffused giving the paddle an illuminated look and feel. For example, the paddle portion may be a clear or partially clear material which includes surface etching, for example, on the perimeter and/or surface of the paddle causing light transmitted within the clear material of the paddle portion to illuminate the etched portions.

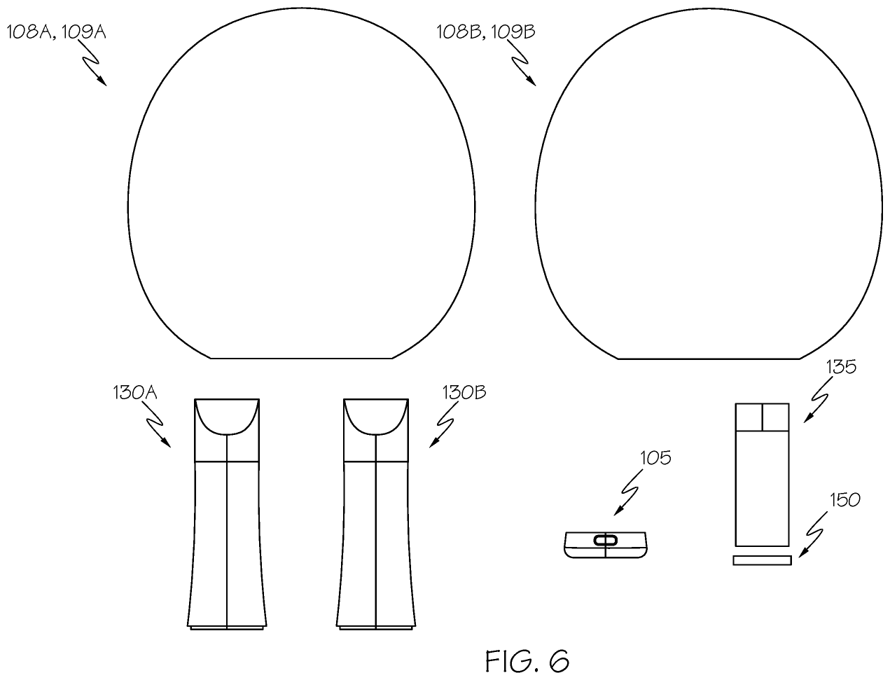

As shown in FIG. 4, the handle face 113 includes a cavity 114 positioned at least partially therethrough. The cavity 114 provides an opening in the frame 110 for the battery 135 (see FIG. 6) to be maintained.

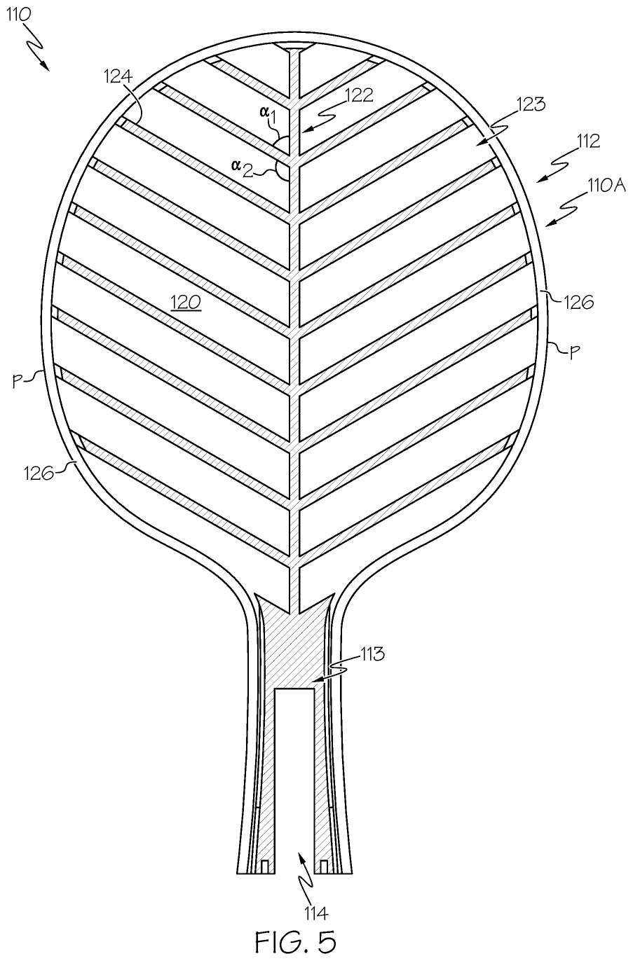

FIG. 5 illustrates an inner surface 120 of one embodiment of the frame 110. In this embodiment, the frame 110 has two shells, and FIG. 5 illustrates an inner surface 120 of one of the shells (shell 110A). Some traditional paddles are made of wood, and therefore have a certain weight and “feel” when striking a ball. Fabricating a paddle out of plastic may cause the paddle to be a weight that is different from a traditional paddle, such as heavier. Some embodiments of the present disclosure address this issue by providing hollow cavities 123 within the frame 110. The hollow cavities 123 reduce the overall amount of material of the paddle 100 and thus the weight of the paddle 100. The cavities are defined by internal strength members that protrude from the inner surface 120. In the illustrated embodiment, the internal strength members include a central strength member 122 and a plurality of branching strength members 124, which define a leaf shape. The branching strength members 124 are angled with respect to the central strength member 122 such that a first angle α₁ is less than a second angle α₂, and the branching strength members 124 are angled in a direction away from the handle portion 104. In other words, the branching strength members 124 form a non-perpendicular connection with the central strength member 122. In embodiments, the central strength member 122 and the branching strength members 124 may be configured to operate as light pipes (light guides) capable of transmitting and diffusing light therefrom. In such embodiments, a light pipe 115 may not be needed to provide illumination about a portion of the perimeter P. That is, the central strength member 122 and the branching strength members 124 may operate as light guides through the material and illuminated the perimeter and/or the faces of the paddle 100.

For example, the first angle α₁ is less 90 degrees and the second angle α₂ greater than 90 degrees. In some embodiments, the first angle cu is between 89 degrees and 80 degrees, between 79 degrees and 70 degrees, between 69 degrees and 60 degrees, between 59 degrees and 50 degrees, between 49 degrees and 40 degrees, between 39 degrees and 30 degrees, between 29 degrees and 20 degrees, between 19 degrees and 10 degrees, between 9 degrees and 1 degree, or an value between 89 degrees and 1 degree. The second angle α₂ is a value of 180 degrees minus the value of the first angle α₁.

The shell 110A of the frame 110 also includes a channel portion 126 that extends at least partially around the perimeter P. When two shells are secured together (e.g., by use of adhesive, sonic welding, and/or the like), the channel portions 126 of each of the two shells align to form a channel 127 in which the light pipe 115 is disposed. It should be understood that the frame 110 may be a unitary component rather than two shells.

Referring briefly to FIG. 6, components of the paddle 100 that are attached to and supported by the frame 110, for example as depicted in FIGS. 4 and 5 are depicted. For example, the paddle 100 includes a foam layer 109A, 109B and/or a rubber layer 108A, 108B on each face 103A, 103B, grips 130A, 130B, an electronics housing 105, a battery 135, and a PCB 150 with electronics for powering and controlling the light sources of the illuminated paddle 100. Assembly of the components including the light pipe 115 and the frame 110 is depicted in further detail with respect to FIG. 15.

The battery 135 is a power source electrically connected to the electronics of the PCB 150. The power source may be a primary battery or a secondary battery such as a rechargeable battery. The secondary battery may be a lithium polymer or the like. For example, the battery may be a lithium ion battery having a capacity of 500 mAh, for example, and undervoltage, overvoltage, and over current protection built in to the protection circuit of the battery pack. The battery may have a capacity capable of generating 10 hours or more of light on a single charge.

Referring now to FIGS. 7A and 7B, different views of a paddle 100 without a light pipe 115 installed are illustrated. FIGS. 7A and 7B illustrate the channel 127 that is formed within the frame 110, which in the illustrated embodiment is defined by a first shell 110A and a second shell 110B. The channel 127 extends about a perimeter P of the paddle. A width (WC) of the channel 127 may be slightly smaller than a width (or diameter) of the light pipe 115 such that the light pipe 115 may be secured within the channel 127 by an interference fit. The channel 127 includes a depth extending from the outer edge of the perimeter of the frame 110 toward the middle of the frame, for example, a depth the corresponds to the width or diameter of the light pipe 115. As such, the light pipe 115 makes a flush surface with the perimeter of the paddle portion 102 and/or the handle portion 104. A flush surface along the length of the handle portion 104 provides the user with a comfortable and unobstructed hold on the grips 130A, 130B of the handle of the paddle 100.

Ends of the branching strength members 125 are exposed within the channel 127. These ends of the branching strength members 125 provide surface area for the light pipe 115 to be secured to by an adhesive. The angled, branching nature of the branching strength members 125 ensures that the ends of the branching strength members 125 substantially match the contour of the channel 127 to provide a maximum surface area for bonding the light pipe 115 to the frame 110. Adhesive may be disposed on the ends of the branching strength members 125 (as well as the central strength member 122). The light pipe 115 may then be disposed on the adhesive and secured to the frame 110.

In some embodiments, the light pipe 115 is further coated with a polymer coating that assists in further securing the light pipe 115 to the frame 110 as well as further diffusing the light propagating within the light pipe to provide an even light distribution.

FIG. 8 illustrates an example electronics housing 105 that is coupled to the handle portion 104 of the frame 110 (e.g., by fasteners 51 and 52 shown in FIG. 15). The electronics housing 105 maintains a charger port 107, control electronics, and one or more light sources 152 (see FIG. 9) that are optically coupled to the light pipe 115. Additionally, the electronics housing 105 includes a button cover 132 for a user to interface with an electronic button 153 (see FIGS. 9 and 15).

However, in some embodiments, light sources may be integrated throughout the frame 110, for example, along the perimeter P or within the frame 110. Integration of the light sources at different locations throughout the frame 110 enables various illumination modes of the paddle 100. For example, the faces of the paddle 100 may be illuminated including or excluding the perimeter P. As another example, portions of the paddle 100 may illuminated by a first color while other portions are illuminated by a second color. In some embodiments, light sources may be integrated within and/or between the foam layers 109, the rubber layers 108, and/or the frame 110 of the paddle 100.

FIG. 9 illustrates an example printed circuit board 150 (PCB) having electronic components, a button 153, and two light sources 152. The printed circuit board 150 is disposed within the electronics housing 105 such that the light sources 152 (e.g., LEDs) are optically coupled with the light pipe 115. The phrase “optically coupled” means light emitted by the light sources 152 enter and propagate within the light pipe 115. The printed circuit board 150 further includes a charger port 107 that is used to charge the battery 135 (see FIGS. 6 and 15).

The PCB 150 may further include one or more sensors such as an accelerometer, a vibration switch, a tilt sensor, a gyroscope, and/or the like. The one or more sensors may be configured to sense the an acceleration and/or speed of movement of the paddle, a force of contact between the paddle and ball, a location of contact with ball on the surface of the paddle and the like. The type and/or color of illumination may be preconfigured to change in response to specified movements, forces, and/or locations of contact that the one or more sensors detect. For example, in some embodiments, the type of the illumination, such as the brightness, intermittent flashing, and the like, or the color of the illumination may be configured to change in response to movement of the paddle and/or contact of the paddle with the ball. Such an embodiment may be utilized for training activities or provide feedback to game play.

The charger port 107 is electrically and mechanically coupled to the PCB 150. The charger port 107 may be a mini-USB, a micro-USB, or a USB-C type port. The charger port 107 enables the battery 135 to be charged from an external power source. The charger port 107 is accessible through an opening in the housing material of the electronics housing 105. A charging port cover may be fitted to selectively close the opening in the housing of the electronics housing 105. The charging port cover may be made of a pliable material such that an interference fit may be achieved with the housing material of the electronics housing 105. A portion of the charging port cover may be coupled to the housing material of the electronics housing 105 such that when the charging port cover is removed from the opening in the electronics housing 105, the charging port cover remains attached to the housing material of the electronics housing 105.

The button 153 is provided to turn the light sources 152 on and off, as well as to cycle through different colors and modes. Actuating the button 153 controls operation of the illuminated paddle 100. For example, actuation of the button 153 turns on or off the one or more light sources 152 and/or changes the mode of the illumination of the one or more light sources 152. Modes of illumination may include high brightness, medium brightness, low brightness, and/or a flashing mode. The brightness may change my change the power delivered to the light illuminating devices. For example, the light emitting devices may provide 75 lumens, 100 lumens, 150 lumens, 200 lumens, or any level between 75 and 200 lumens. Each brightness mode may be configured to provide a different lumen level. Modes of illumination may also include changing the color of the light emitted. In some embodiments, the one or more light sources 152 may be configured cycle or morph from a first color to a second color. As used herein, the term morph refers to a gradual transition from one color or brightness to another.

The button 153 is configured to be actionable through the electronics housing 105 by way of openings in the housing and a button cover 133. In embodiments, operation (or activation) of the button 153 causes circuitry on the PCB 150 to turn on or off the one or more light sources 152. The button cover 133 may be may be made of a pliable material such that a force applied to the button cover 133 actuates the button 153.

For example, operating the button 153 one time powers on the one or more light sources 152 and begins rotation or morphing through various colors of light. The one or more light sources 152 include white LEDs and/or RGBW LEDs.

Operating the button 153 two times may stop the color rotation of the LEDs on the current color. Operating the button 153 three times may power off the one or more light sources 152. In other embodiments, operating the button 153 an additional time while the light source is powered on may set the one or more light sources 152 to low brightness. Operating the button 153 a second additional time sets the one or more light sources 152 to high brightness. Operating the button 153 a third additional time sets the one or more light sources 152 to flash at high brightness. Operating the button 153 a fourth additional time may power off the one or more light sources 152. Operating the buttons in rapid succession can cause one of a number various modes of illumination. The aforementioned operation sequence is merely an example.

In another embodiment, operating the button 153 one time powers on the one or more light sources 152 at low brightness. Operating the button 153 two times sets the one or more light sources 152 to high brightness. Operating the button 153 three times sets the one or more light sources 152 to flash at high brightness. Operating the button 153 four times powers off the one or more light sources 152.

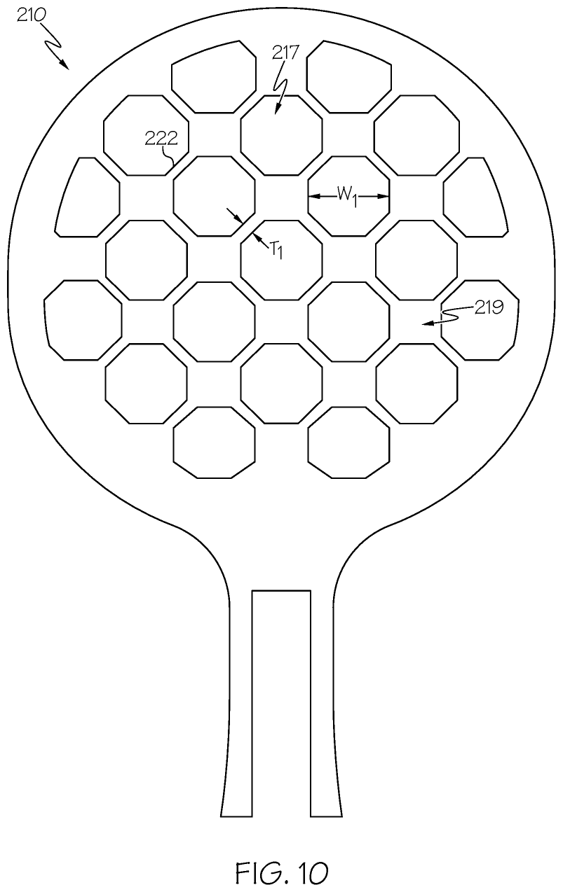

Referring to FIG. 10 an example frame 210 wherein hexagon cavities 217 are formed within the paddle portion 102 is illustrated. It should be understood that the frame of the paddle 100 may include internal strength members having a configuration (e.g., a geometric structure) other than the branching configuration shown in FIG. 5. In the frame 210 of FIG. 10, the hexagon cavities 217 have a width W₁ and are formed by strength members 222 having a thickness T₁.

The hexagon cavities 217 may cause “dead” spots on the paddle which cause the ball to have different impact characteristics as opposed to locations on the paddle where there is solid frame material. To provide fewer “dead” spots on the paddle, central square portions 219 of solid frame material are provided between hexagon cavities 217. These central square portions make it more likely that the ball will strike solid frame material.

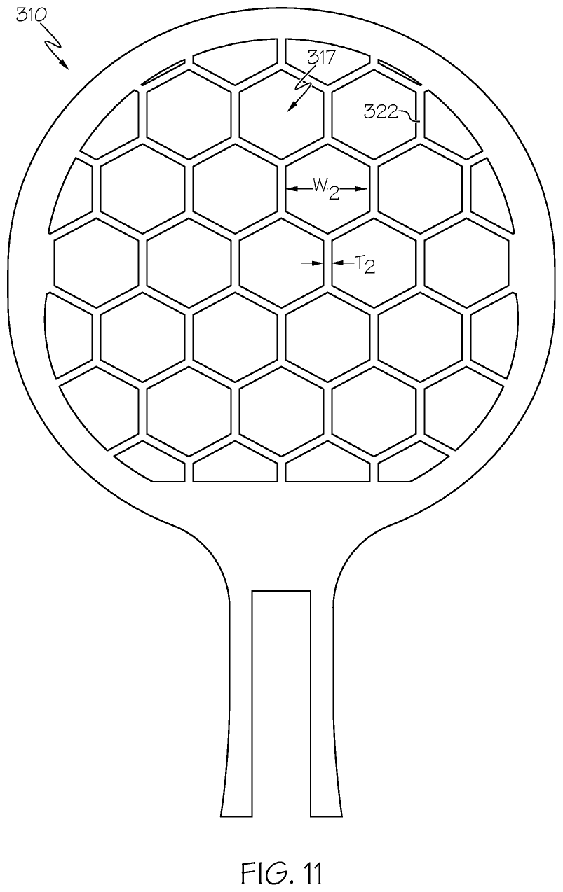

FIG. 11 illustrates another frame 310 that includes hexagon cavities 317 having a width W₂, which may be the same or different from width W₁. The strength members 322 of this example have a thickness T₂ that is less than thickness T₁, resulting in more hexagon cavities 317 than the frame 210 of FIG. 10.

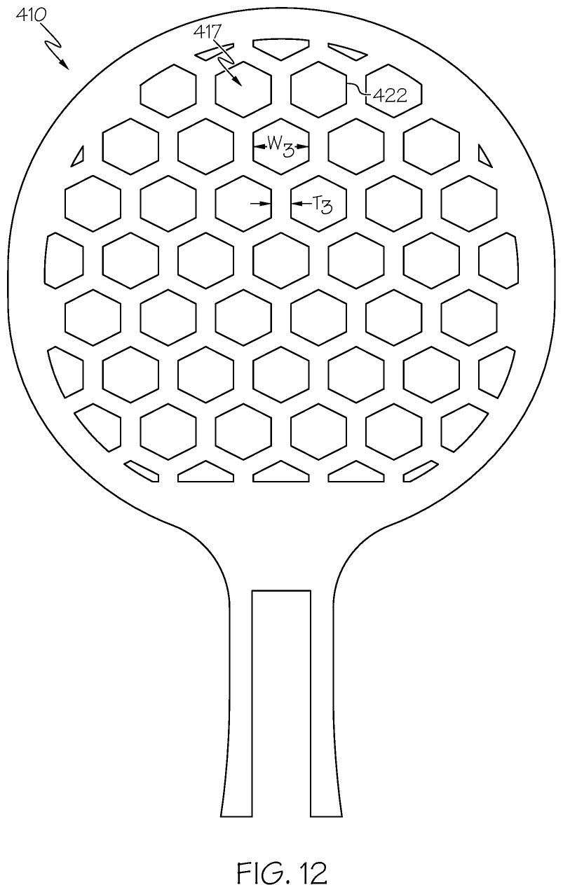

FIG. 12 illustrates another example frame 410 that includes hexagon cavities 417 having a width W₃ that is less than width W₁ of the example frame 210 depicted by FIG. 10. The strength members 422 of this example have a thickness T₃ that is greater than thicknesses T₁ and T₂, resulting in more frame material than the example frame 310 of FIG. 11.

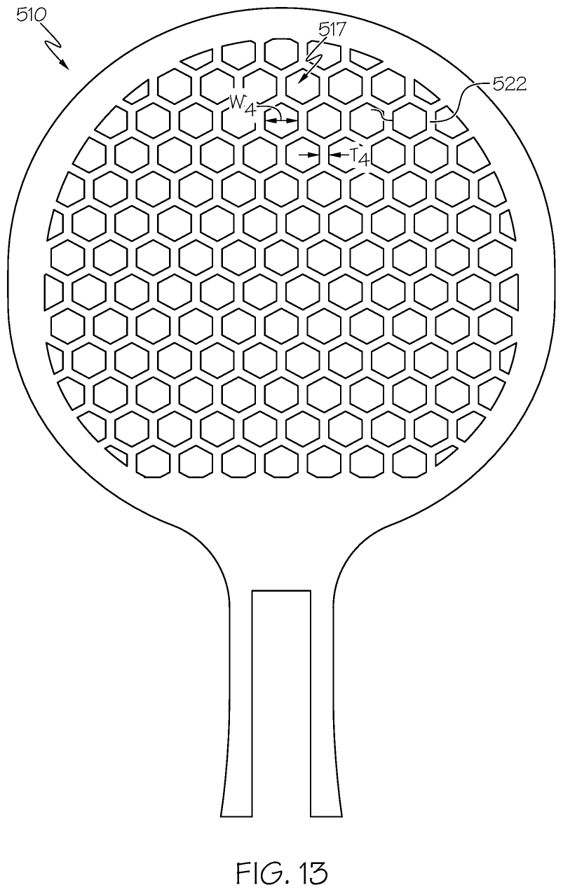

FIG. 13 illustrates another example frame 510 that includes hexagon cavities 517 having a width W₄ that is less than width W₃ of the example frame 410 depicted by FIG. 12. The strength members 522 of this example have a thickness T₄ that is less than thickness T₃, resulting in more hexagon cavities 517 than the example frame 410 depicted by FIG. 12.

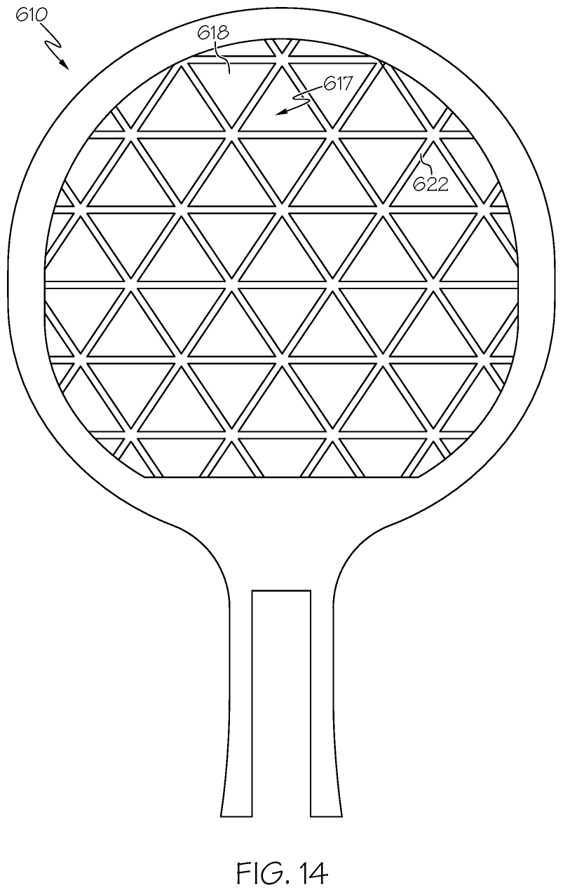

Other configurations for the frame of the paddle 100 are also possible. FIG. 14 illustrates an example frame 610 having support members 622 that define interlaced triangular cavities 617. Further, in this example, the frame 610 includes a backing face 618 defined by material in the triangular cavities 617.

Referring to FIG. 15, an illustrative exploded assembly view of the paddle 100 is provided. As described herein, the frame 110 includes an internal geometric structure that provides a predetermined weight, weight distribution across the paddle 100, and a feel of play from the surfaces of the paddle 100. At least a portion of the perimeter of the frame 110 includes a channel 127 (see FIGS. 7A and 7B) for receiving and retaining the light pipe 115. In embodiments, the light pipe 115 extends around the perimeter of the paddle portion 102 and the handle portion 104 of the paddle 100. However, this is not a requirement. In some instances, the light pipe 115 may not extend along the lengthwise portion of the perimeter of the handle portion 104, or may not extend along the entire perimeter of the paddle portion 102. When assembled, the ends 116A, 116B of the light pipe 115 extend into the electronics housing 105 coupled to the handle portion 104 of the frame 110. This enables the light pipe 115 to be aligned with the one or more light sources 152 through one or more alignment features of the electronics housing 105.

As shown, the PCB 150 includes a button 153 that is covered by a button cover 133 and received into the electronics housing 105 which includes an opening for the button cover to align with the external surface of the electronics housing 105 and be actuatable by a user. The electronics housing 105 may be glued or otherwise fastened to the frame 110, for example, with one or more fasteners 51, 52, such as screws.

The battery 135 is disposed within a cavity 114 formed in the length of the handle portion 104 of the frame 110 and enclosed on opposing sides by the grips 130A, 130B. The battery 135 may be mounted and secured with glue therein. As described with reference to FIG. 1, the paddle portion 102 of the paddle has a two faces 103A, 103B one of each side of the frame 110 such that the two faces 103A, 103B oppose each other. Each of the two faces 103A, 103B support a foam layer 109A, 109B, respectively, and a rubber layer 108A, 108B respectively. However, it is understood that in some embodiments the paddle portion 102 may not include a foam layer 109A, 109B and instead include a rubber layer 108A, 108B directly supported by the frame 110.

Implementation examples are described in the following clauses.

An illuminated paddle having a frame comprising a paddle portion, a handle portion extending from the paddle portion, a perimeter that extends around the paddle portion and the handle portion, and a channel positioned along at least a portion of the perimeter, the paddle portion comprising a plurality of internal strength members that define a plurality of cavities; a light source assembly disposed at an end of the handle portion, the light source assembly comprising at least one light source; and a light pipe disposed within at least a portion of the channel of the frame, wherein the light pipe is optically coupled to the at least one light source.

The illuminated paddle of any preceding clause, wherein the plurality of internal strength members comprises a central strength member extending from the handle portion through the paddle portion and a plurality of branching strength members extending from the central strength member outward toward the perimeter of the frame.

The illuminated paddle of any preceding clause, wherein the plurality of branching strength members form a non-perpendicular angle with the central strength member.

The illuminated paddle of any preceding clause, wherein the plurality of branching strength members extend from the central strength member in a direction away from the handle portion.

The illuminated paddle of any preceding clause, wherein a width of the channel is smaller than a diameter of the light pipe such that an interference fit between the light pipe and the channel are formed when the light pipe is received by the channel.

The illuminated paddle of any preceding clause, wherein the light pipe is disposed around the perimeter of the paddle portion.

The illuminated paddle of any preceding clause, wherein the light pipe is disposed around the perimeter of the paddle portion and the handle portion.

The illuminated paddle of any preceding clause, wherein the handle portion of the frame comprises a cavity, the cavity is sized to receive and retain a battery.

The illuminated paddle of any preceding clause, further comprising a battery disposed within the handle portion.

The illuminated paddle of any preceding clause, wherein the handle portion further comprises two grips, the two grips are secured to opposing faces of the handle portion of the frame and enclose the battery disposed within a cavity of the handle portion.

The illuminated paddle of any preceding clause, wherein the handle portion comprises an electronics housing, the electronics housing retains a printed circuit board comprising the at least one light source, a button, and electronic components electrically coupled to the battery and configured to control operation of the at least one light source in response to activation of the button.

The illuminated paddle of any preceding clause, wherein the electronics housing is positioned on the end of the handle portion opposite the paddle portion.

The illuminated paddle of any preceding clause, wherein the electronics housing is attached to the end of the handle portion with one or more screws.

The illuminated paddle of any preceding clause, wherein the printed circuit board further comprises a charger port electrically coupled to the battery to charge the battery when a power source is connected to the charger port.

The illuminated paddle of any preceding clause, wherein the electronics housing comprises an opening and a button cover positioned within the opening, whereby the button cover enables activation of the button disposed on the printed circuit board within the electronics housing.

The illuminated paddle of any preceding clause, wherein activation of the button controls operation of the at least one light source in a plurality of modes comprising activating the at least one light source to cycle through a plurality of colors, causing the at least one light source to hold the cycling through the plurality of colors on a selected color, and deactivating the at least one light source.

The illuminated paddle of any preceding clause, wherein the at least one light source is configured to generate one or more colors of light.

An illuminated paddle having a frame comprising a paddle portion, a handle portion extending from the paddle portion, a perimeter that extends around the paddle portion and the handle portion, and a channel positioned along at least a portion of the perimeter, the paddle portion comprising a plurality of internal strength members that define a plurality of cavities; a light source assembly disposed at an end of the handle portion, the light source assembly comprising at least one light source; a light pipe disposed within at least a portion of the channel of the frame, wherein the light pipe is optically coupled to the at least one light source; a first rubber layer secured to a first face of the paddle portion of the frame; a second rubber layer secured to a second face opposite the first face of the paddle portion of the frame; a cavity formed in the handle portion of the frame, the cavity is sized to receive and retain a battery; and two grips, each of the two grips secured to opposing faces of the handle portion of the frame and enclose the battery disposed within the cavity of the handle portion of the frame.

The illuminated paddle of any preceding clause, wherein the plurality of internal strength members comprises a central strength member extending from the handle portion through the paddle portion and a plurality of branching strength members extending from the central strength member outward toward the perimeter of the frame, the plurality of branching strength members form a non-perpendicular angle with the central strength member, and the plurality of branching strength members extend from the central strength member in a direction away from the handle portion.

The illuminated paddle of any preceding clause, wherein the handle portion comprises an electronics housing, the electronics housing retains a printed circuit board comprising the at least one light source, a button, and electronic components electrically coupled to the battery and configured to control operation of the at least one light source in response to activation of the button.

The terminology used herein is for the purpose of describing particular aspects only and is not intended to be limiting. As used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. The term “or a combination thereof” means a combination including at least one of the foregoing elements.

It is noted that recitations herein of a component of the embodiments being “configured” in a particular way, “configured” to embody a particular property, or function in a particular manner, are structural recitations as opposed to recitations of intended use. More specifically, the references herein to the manner in which a component is “configured” denotes an existing physical condition of the component and, as such, is to be taken as a definite recitation of the structural characteristics of the component.

It will be apparent to those skilled in the art that various modifications and variations can be made without departing from the spirit or scope of the disclosure. Since modifications, combinations, sub-combinations and variations of the disclosed embodiments incorporating the spirit and substance of the disclosure may occur to persons skilled in the art, the disclosure should be construed to include everything within the scope of the appended claims and their equivalents.

While various embodiments of the present disclosure have been described above, it should be understood that they have been presented by way of example only, and not limitation. It will be apparent to persons skilled in the relevant art that various changes in form and detail can be made therein without departing from the spirit and scope of the present disclosure. Thus, the breadth and scope of the present disclosure should not be limited by any of the above-described exemplary embodiments, but should be defined only in accordance with the following claims and their equivalents.

It is noted that one or more of the following claims utilize the term “wherein” as a transitional phrase. For the purposes of defining the embodiments of the present disclosure, it is noted that this term is introduced in the claims as an open-ended transitional phrase that is used to introduce a recitation of a series of characteristics of the structure and should be interpreted in like manner as the more commonly used open-ended preamble term “comprising.”

Although the disclosure has been illustrated and described herein with reference to explanatory embodiments and specific examples thereof, it will be readily apparent to those of ordinary skill in the art that other embodiments and examples can perform similar functions and/or achieve like results. All such equivalent embodiments and examples are within the spirit and scope of the disclosure and are intended to be covered by the appended claims. It will also be apparent to those skilled in the art that various modifications and variations can be made to the concepts disclosed without departing from the spirit and scope of the same. Thus, it is intended that the present application cover the modifications and variations provided they come within the scope of the appended claims and their equivalents.

What is claimed is:

1. An illuminated paddle comprising:
a frame comprising a paddle portion, a handle portion extending from the paddle portion, a perimeter that extends around the paddle portion and the handle portion, and a channel positioned along at least a portion of the perimeter, the paddle portion comprising a plurality of internal strength members that define a plurality of cavities;
a light source assembly disposed at an end of the handle portion, the light source assembly comprising at least one light source; and
a light pipe disposed within at least a portion of the channel of the frame, wherein the light pipe is optically coupled to the at least one light source.

2. The illuminated paddle of claim 1, wherein the plurality of internal strength members comprises a central strength member extending from the handle portion through the paddle portion and a plurality of branching strength members extending from the central strength member outward toward the perimeter of the frame.

3. The illuminated paddle of claim 2, wherein the plurality of branching strength members form a non-perpendicular angle with the central strength member.

4. The illuminated paddle of claim 3, wherein the plurality of branching strength members extend from the central strength member in a direction away from the handle portion.

5. The illuminated paddle of claim 1, wherein a width of the channel is smaller than a diameter of the light pipe such that an interference fit between the light pipe and the channel are formed when the light pipe is received by the channel.

6. The illuminated paddle of claim 1, wherein the light pipe is disposed around the perimeter of the paddle portion.

7. The illuminated paddle of claim 1, wherein the light pipe is disposed around the perimeter of the paddle portion and the handle portion.

8. The illuminated paddle of claim 1, wherein the handle portion of the frame comprises a cavity, the cavity is sized to receive and retain a battery.

9. The illuminated paddle of claim 1, further comprising a battery disposed within the handle portion.

10. The illuminated paddle of claim 9, wherein the handle portion further comprises two grips, the two grips are secured to opposing faces of the handle portion of the frame and enclose the battery disposed within a cavity of the handle portion.

11. The illuminated paddle of claim 9, wherein the handle portion comprises an electronics housing, the electronics housing retains a printed circuit board comprising the at least one light source, a button, and electronic components electrically coupled to the battery and configured to control operation of the at least one light source in response to activation of the button.

12. The illuminated paddle of claim 11, wherein the electronics housing is positioned on the end of the handle portion opposite the paddle portion.

13. The illuminated paddle of claim 12, wherein the electronics housing is attached to the end of the handle portion with one or more screws.

14. The illuminated paddle of claim 11, wherein the printed circuit board further comprises a charger port electrically coupled to the battery to charge the battery when a power source is connected to the charger port.

15. The illuminated paddle of claim 11, wherein the electronics housing comprises an opening and a button cover positioned within the opening, whereby the button cover enables activation of the button disposed on the printed circuit board within the electronics housing.

16. The illuminated paddle of claim 9, wherein activation of the button controls operation of the at least one light source in a plurality of modes comprising:
activating the at least one light source to cycle through a plurality of colors,
causing the at least one light source to hold the cycling through the plurality of colors on a selected color, and
deactivating the at least one light source.

17. The illuminated paddle of claim 1, wherein the at least one light source is configured to generate one or more colors of light.

18. An illuminated paddle comprising:
a frame comprising a paddle portion, a handle portion extending from the paddle portion, a perimeter that extends around the paddle portion and the handle portion, and a channel positioned along at least a portion of the perimeter, the paddle portion comprising a plurality of internal strength members that define a plurality of cavities;
a light source assembly disposed at an end of the handle portion, the light source assembly comprising at least one light source;
a light pipe disposed within at least a portion of the channel of the frame, wherein the light pipe is optically coupled to the at least one light source;
a first rubber layer secured to a first face of the paddle portion of the frame;
a second rubber layer secured to a second face opposite the first face of the paddle portion of the frame;
a cavity formed in the handle portion of the frame, the cavity is sized to receive and retain a battery; and
two grips, each of the two grips secured to opposing faces of the handle portion of the frame and enclose the battery disposed within the cavity of the handle portion of the frame.

19. The illuminated paddle of claim 18, wherein the plurality of internal strength members comprises a central strength member extending from the handle portion through the paddle portion and a plurality of branching strength members extending from the central strength member outward toward the perimeter of the frame, the plurality of branching strength members form a non-perpendicular angle with the central strength member, and the plurality of branching strength members extend from the central strength member in a direction away from the handle portion.

20. The illuminated paddle of claim 18, wherein the handle portion comprises an electronics housing, the electronics housing retains a printed circuit board comprising the at least one light source, a button, and electronic components electrically coupled to the battery and configured to control operation of the at least one light source in response to activation of the button.
